(19) United States
(12) Patent Application Publication
(10) Pub. No.: US 2019/0263271 A1
(43) Pub. Date: Aug. 29, 2019

(54) EXECUTION OF CHARGE SESSION SWAP BASED ON CHARGING PRIORITY

(71) Applicant: GM GLOBAL TECHNOLOGY OPERATIONS LLC, Detroit, MI (US)

(72) Inventors: Ryan Ashby, Novi, MI (US); Brandon R. Jones, White Lake, MI (US); Matthew S. Stout, Royal Oak, MI (US); Jeanette C. Kurnik, Linden, MI (US)

(21) Appl. No.: 15/906,542

(22) Filed: Feb. 27, 2018

(51) Int. Cl. B60L 11/18; G06Q 10/06; G06Q 40/04; G06Q 50/06

(52) U.S. Cl. CPC B60L 11/1848; G06Q 10/06316; B60L 2230/40; G06Q 50/06; G06Q 40/04

(57) ABSTRACT

A method and system for use in performing a real-time charge session swap between a primary electric vehicle located at a charging station of an electric vehicle charging facility and a secondary electric vehicle located at the electric vehicle charging facility, comprising the steps of: (a) receiving via a mobile wireless device a request for an electric vehicle charge session swap; (b) receiving one or more charge priority metrics from the secondary electric vehicle indicating a level of need for charging of the secondary electric vehicle; (c) providing an acceptance of the request for the electric vehicle charge session swap based on an evaluation of the charge priority metrics; and (d) notifying the secondary electric vehicle of the acceptance, thereby communicating the availability of the charging station for use by the secondary electric vehicle to carry out the electric vehicle charge session swap.

### INTRODUCTION

The present invention relates to methods and systems for charging electric vehicles owned or operated by different people at an electric vehicle charging facility.

With the growing number of vehicles on the road that require an electric charge to operate and the sometimes limited availability of charging facilities, there exists the possibility that a particular charging facility might experience a backup of vehicles waiting for an open charging station in which to recharge.

### SUMMARY

According to one aspect of the invention, there is provided a method of performing a real-time charge session swap between a primary electric vehicle and a secondary electric vehicle located at a charging facility, the method including the steps of: (a) receiving via a mobile wireless device a request for an electric vehicle charge session swap indicating a request by the secondary electric vehicle for the primary electric vehicle to suspend charging of the primary electric vehicle by the charging station prior to completion of charging by the primary electric vehicle; (b) receiving one or more charge priority metrics from the secondary electric vehicle indicating a level of need for charging of the secondary electric vehicle; (c) providing an acceptance of the request for the electric vehicle charge session swap based on an evaluation of the charge priority metrics, and notifying the secondary electric vehicle of the acceptance; (d) thereby communicating the availability of the charging station for use by the secondary electric vehicle to carry out the electric vehicle charge session swap.

According to various embodiments, this method may further include any one of the following features or any technically-feasible combination of some or all of these features:
wherein the steps are carried out by a service provider using at least one computing device having an electronic processor, computer-readable memory accessible by the processor, and software stored on the memory that, when executed by the processor, carries out the steps of the method;
wherein the charge priority metrics include a charge bid from a user of the secondary electric vehicle, and wherein the method further comprises the steps of providing the charge bid to a user of the primary electric vehicle prior to step (c) and, after step (d), confirming execution of the electric vehicle charge session swap and initiating a payment from the user of the secondary electric vehicle to the user of the primary electric vehicle based on the charge bid;
wherein the method is implemented at least in part using an application stored on the mobile wireless device of a user of the primary electric vehicle, wherein the application is associated with a primary user account stored at a central facility and, when executed on the mobile wireless device, the application accesses the user account at the central facility, and wherein the method further comprises, after step (d), confirming execution of the electric vehicle charge session swap and initiating a crediting of the primary user account in response to confirming execution of the electric vehicle charge session swap;
wherein the charge priority metrics include a charge need of the secondary electric vehicle and wherein the method comprises carrying out steps (c) and (d) following a determination that the charge need meets a minimum threshold;
wherein the request in step (a) for the electric vehicle charge session swap by the secondary electric vehicle is received from a user of the secondary electric vehicle via a handheld wireless device operated by the user or via a telematics unit installed in the vehicle, and wherein notifying the secondary electric vehicle in step (d) of the acceptance comprises notifying the user of the secondary electric vehicle via the handheld wireless device or the telematics unit;
further comprising automatically determining the acceptance based on the charge priority metrics and a weighted scoring function that is weighted based on data received from an owner of the primary electric vehicle;
wherein the method comprises automatically carrying out the determining step and steps (c) and (d) following a determination that the primary electric vehicle has a minimum state of charge;
further comprising receiving an identifier of the primary electric vehicle from a user of the secondary electric vehicle via a handheld wireless device carried by the user of the secondary electric vehicle; and/or
further comprising receiving an identifier of the primary electric vehicle that was obtained automatically by the secondary electric vehicle using short range wireless communication between the primary and secondary electric vehicles.

According to another aspect of the invention, there is provided a system for use in performing a real-time charge session swap between a primary electric vehicle located at a charging station of an electric vehicle charging facility and a secondary electric vehicle located at the electric vehicle charging facility, the system comprising a computing device having an electronic processor, computer-readable memory accessible by the processor, and software stored on the memory that, when executed by the processor, configures the system to: a) receive via a mobile wireless device a request for an electric vehicle charge session swap indicating a request by the secondary electric vehicle for the primary electric vehicle to suspend charging of the primary electric vehicle by the charging station prior to completion of charging by the primary electric vehicle; b) receive one or more charge priority metrics from the secondary electric vehicle indicating a level of need for charging of the secondary electric vehicle; c) provide an acceptance of the request for the electric vehicle charge session swap based on an evaluation of the charge priority metrics; and d) notify the secondary electric vehicle of the acceptance, thereby communicating the availability of the charging station for use by the secondary electric vehicle to carry out the electric vehicle charge session swap.

According to various embodiments, the method of the preceding paragraph may further include any one of the following features or any technically-feasible combination of some or all of these features:
wherein the computing device is located remotely of the electric vehicle charging facility;
wherein the computing device is located at the electric vehicle charging facility;
wherein the charge priority metrics include a charge bid from a user of the secondary electric vehicle, and wherein, when executing the software using the processor, the computing device is configured to provide the charge bid to a user of the primary electric vehicle and, after notifying the secondary vehicle of the acceptance, confirm execution of the electric vehicle charge session swap and initiate a payment from the user of the secondary electric vehicle to the user of the primary electric vehicle based on the charge bid; and/or
wherein the request for the electric vehicle charge session swap by the secondary electric vehicle is received from a user of the secondary electric vehicle via a handheld wireless device operated by the user or via a telematics unit installed in the vehicle, and wherein, when executing the software using the processor, the computing device is configured to notify the user of the secondary electric vehicle of the acceptance via the handheld wireless device or the telematics unit.

According to a third aspect of the invention, there is provided a system for a non-transitory computer-readable medium for use in performing a real-time charge session swap between a primary electric vehicle located at a charging station of an electric vehicle charging facility and a secondary electric vehicle located at the electric vehicle charging facility, the computer-readable medium having stored thereon software that, when executed by an electronic processor, configures the processor to: a) receive via a mobile wireless device a request for an electric vehicle charge session swap indicating a request by the secondary electric vehicle for the primary electric vehicle to suspend charging of the primary electric vehicle by the charging station prior to completion of charging by the primary electric vehicle; b) receive one or more charge priority metrics from the secondary electric vehicle indicating a level of need for charging of the secondary electric vehicle; c) provide an acceptance of the request for the electric vehicle charge session swap based on an evaluation of the charge priority metrics; and d) notify the secondary electric vehicle of the acceptance, thereby communicating the availability of the charging station for use by the secondary electric vehicle to carry out the electric vehicle charge session swap.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein;

FIG. 2 is a flow chart illustrating an embodiment of a method of establishing real time charge session swap between a secondary and primary electric vehicle; and

FIG. 3 is a flow chart illustrating another embodiment of a method of establishing real time charge session swap between a secondary and primary electric vehicle.

### DETAILED DESCRIPTION

The methods and system described below provides communication between a primary electric vehicle (EV) that is charging in place at an electric vehicle charging facility and a secondary electric vehicle that arrives at the charging facility while the primary EV is charging, so as to enable a real-time charge session swap between the vehicles. In this way, the primary EV is able to give up its charging station spot before being fully charged to the secondary EV in exchange for consideration or otherwise. And this enables the secondary EV owner or user to take over the charging station under circumstances such as, for example, when the user of the secondary EV is in a rush or that vehicle has a low state of charge. The decision by the primary EV owner or user to prematurely stop charging of the vehicle may be done based on a conveyance of charge priority metrics indicating a level of need for charging by the secondary EV. A “level of need” for charging may be objective (e.g., based solely on vehicle state of charge, distance to be traveled, or distance to the next charging station) or subjective (e.g., dependent on the level of desire by the secondary electric vehicle operator to obtain charging now at the specific charging facility). Thus, in some scenarios, the secondary EV user may desire to incentivize or persuade the first EV owner to relinquish use of the charging station in favor of the second EV.

According to several embodiments, the method and/or system can enable a real-time charge session swap between a primary and a secondary EV user through use of mobile wireless devices associated with the user of the EVs or with the EVs. “Mobile wireless devices” can include handheld devices such as smartphones as well as OEM or aftermarket vehicle-mounted telematics units and other such devices that are capable of using wireless technology to communicate. As used herein, an “electric vehicle” (EV) is a motor vehicle for which propulsion is carried out using one or more electric motors and, includes vehicles deriving their electric power solely from batteries, fuel cells, or other electric storage devices, or from fossil or other fuel based devices such as an internal combustion engine. And, as used herein, an “electric vehicle charging facility” is a physical service location that includes one or more electric charging stations that may be used by electric vehicles.

In one embodiment, a method for performing a real-time charge session swap for EVs can be provided such that a primary EV user can relinquish their charging station in favor of a secondary EV user without having to directly interact with the primary EV user. This method and/or system can include initiating communications between a primary and a secondary EV user using a mobile wireless device; identifying charge priority metrics from the secondary EV user; relaying the charge priority metrics to the primary EV user; and then receiving a response from the primary EV user. As used herein, “charge priority metrics” may include charge need metrics, charge bid metrics, or both. Charge need metrics can be used to indicate how essential charging is for the secondary EV user in order for travel needs to be met (or other related needs), which can include departure time, present state of energy, distance to next destination, and other factors that may influence the EV user's desire to charge their EV sooner. Charge bid metrics can represent a financial incentive (or other consideration) that the secondary EV user intends to offer the primary EV user in consideration for relinquishing their use of a charging station or stall.

For example, charge bid metrics can be conveyed to a user of the primary EV using mobile devices of the users of the primary EV and secondary EV. A user of the secondary EV can use their mobile device to input or select charge bid metrics, which can then be sent to a mobile device of the primary EV user. The primary EV user can then agree to relinquish control of the station in exchange for the charge bid amount. Various embodiments exist, as will be discussed in more detail below.

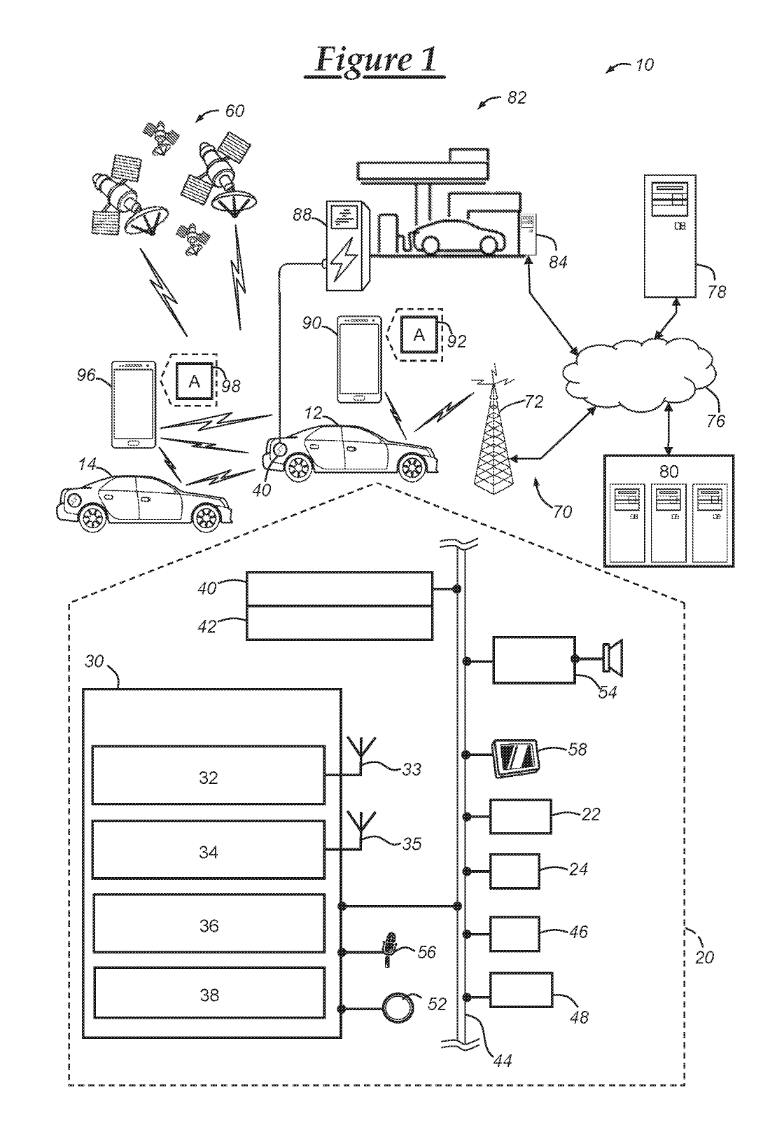

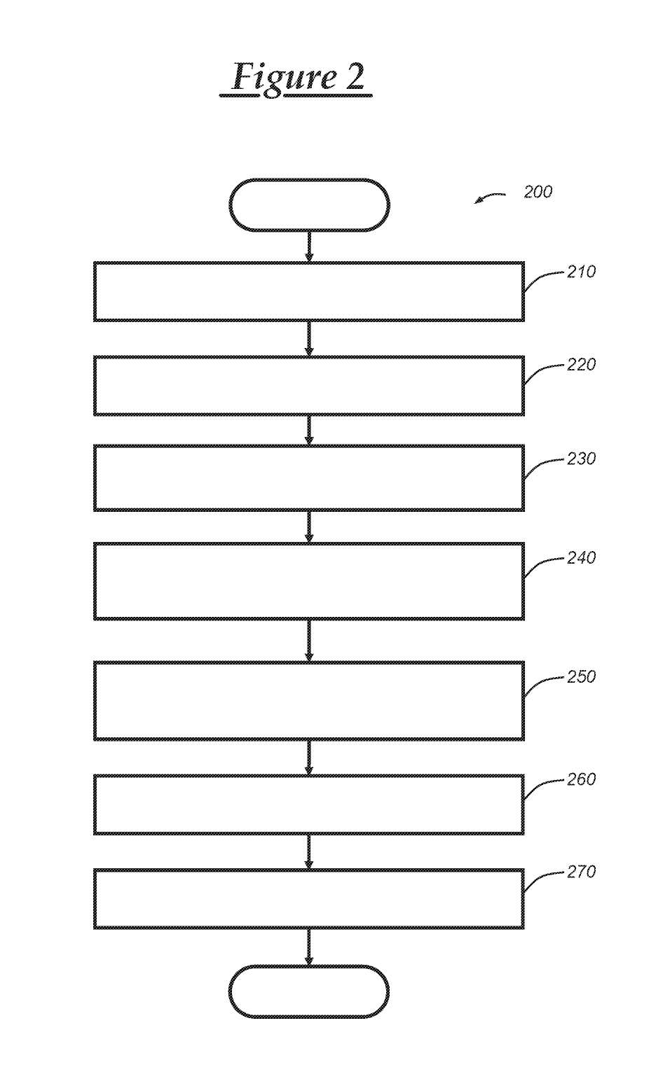

With reference to FIG. 1, there is shown an operating environment that comprises a communications system 10 that can be used to implement a method 200 (FIG. 2) disclosed herein. The communications system 10 generally includes a primary electric vehicle (EV) 12 with a wireless communications device 30, a secondary EV 14 with a wireless communications device (not shown), a constellation of satellites 60, a wireless carrier system 70, a land communications network 76, a computer 78, a remote facility 80, an electric vehicle charging facility 82, a first mobile wireless device 90 which is used by either the primary EV 14 (or a user of the primary EV 12) or by a service provider, and a second mobile wireless device 96 that is used by the secondary EV 14 (or a user of the secondary EV 14). It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of a type of the vehicle communications system 10; however, other systems not shown here could employ the disclosed method as well.

The wireless carrier system 70 may be any of one or more suitable cellular telephone systems. The carrier system 70 is shown as including a cellular tower 72; however, the carrier system 70 may include one or more of the following components (e.g., depending on the cellular technology): cellular towers, base transceiver stations, mobile switching centers, base station controllers, evolved nodes (e.g., eNodeBs), mobility management entities (MMEs), serving and PGN gateways, etc., as well as any other networking components required to connect the wireless carrier system 70 with the land network 76 or to connect the wireless carrier system 70 with user equipment (UE) (e.g., the wireless communications device 30, or the mobile wireless devices 90 and 96). The wireless carrier system 70 can implement any suitable communications technology, including for example GSM/GPRS technology, CDMA or CDMA2000 technology, LTE technology, etc. In general, the wireless carrier systems 70, their components, the arrangement of their components, the interaction between the components, etc. is generally known in the art.

Apart from using the wireless carrier system 70, a different wireless carrier system in the form of satellite communication can be used to provide uni-directional or bi-directional communication with the EVs 12 and 14. This can be done using one or more communication satellites (not shown) and an uplink transmitting station (not shown). Uni-directional communication can be, for example, satellite radio services, wherein programming content (news, music, etc.) is received by the uplink transmitting station, packaged for upload, and then sent to the satellite, which broadcasts the programming to subscribers. Bi-directional communication can be, for example, satellite telephony services using the one or more communication satellites to relay telephone communications between the primary EV 12 or secondary EV 14 and the uplink transmitting station. By way of example of the bi-directional communication can be used to transmit the charge priority metrics such as minimum charge, charge need, duration of charge session or charge bid just to name a few. If used, this satellite telephony can be utilized either in addition to or in lieu of the wireless carrier system 70.

The land network 76 may be a conventional land-based telecommunications network that is connected to one or more landline telephones and connects the wireless carrier system 70 to the remote facility 80. For example, the land network 76 may include a public switched telephone network (PSTN) such as that used to provide hardwired telephony, packet-switched data communications, and/or the Internet infrastructure. One or more segments of the land network 76 could be implemented through the use of a standard wired network, a fiber or other optical network, a cable network, power lines, other wireless networks such as wireless local area networks (WLANs), networks providing broadband wireless access (BWA), or any combination thereof.

The computer 78 can be one or more computers (only one shown) accessible via a private or public network such as the Internet. Each such computer 78 can be used for one or more purposes, such as a web server accessible by the primary EV 12, the secondary EV 14, the first mobile wireless device 90, or the second mobile wireless device 96. The other such accessible computers 78 can be, for example: a service center computer where diagnostic information and other vehicle data can be uploaded from EVs 12,14 or mobile devices 90,96; a client computer used by the vehicle owner or other subscriber for such purposes as accessing or receiving vehicle data, setting up or configuring subscriber preferences, or controlling vehicle functions, whether by communicating with the primary EV 12, the secondary EV 14, and/or the remote facility 80. The computer 78 can also be used for providing Internet connectivity such as DNS services or as a network address server that uses DHCP or other suitable protocol to assign an IP address to the primary EV 12 and/or the secondary EV 14.

The remote facility 80 may be designed to provide the EVs 12,14 and the mobile wireless devices 90,96 with a number of different system back-end functions. For example, the remote facility 80 may be used in part to implement the charge session swap between primary EV 12 and the secondary EV 14. In such a case, the remote facility 80 may coordinate the time window, store data pertaining to other aspects of the charge session swap of primary EV 12 and secondary EV 14, and/or provide authentication and authorization data to SRWC devices, users, and/or vehicles, such as the mobile wireless devices 90,96. The remote facility 80 may include one or more switches, servers, databases, live advisors, as well as an automated voice response system (VRS), all of which are known in the art. The remote facility 80 may include any or all of these various components, and preferably, each of the various components are coupled to one another via a wired or wireless local area network. The remote facility 80 may receive and transmit data via a modem connected to the land network 76. A database at the remote facility 80 can store account information such as subscriber authentication information, vehicle identifiers, profile records, behavioral patterns, and other pertinent subscriber information. Data transmissions may also be conducted by wireless systems, such as IEEE 802.11x, GPRS, and the like. Although the illustrated embodiment has been described as it would be used in conjunction with a manned remote facility 80 using a live advisor, it will be appreciated that the remote facility 80 can instead utilize a VRS as an automated advisor or, a combination of the VRS and the live advisor can be used. Information or data stored at the remote facility 80 can be sent to one or more vehicles or other devices (e.g., the mobile wireless devices 90 and 96) to carry out numerous functions and services. The primary EV 12, the secondary EV 14, and the mobile wireless devices 90 and 96 can send data or information to the remote facility 80, which can then store such information.

The mobile wireless devices 90 and 96 are short-range wireless communication (SRWC) devices (i.e., a device capable of SRWC). These devices may include: hardware, software, and/or firmware enabling cellular telecommunications and SRWC as well as other mobile device applications (or “apps”), such as a charge session swap application 92,98. The hardware of the mobile wireless devices 90 and 96 may comprise: a processor and memory (e.g., non-transitory computer readable medium accessible by the processor) for storing the software needed to implement the charge session swap application 92 and 98. The wireless devices 90 and 96 may include other software apps (e.g., having a software app or graphical user interface (GUI)), which may be preinstalled or installed by the user (or manufacturer). One implementation of an app may enable a remote facility to communicate with the primary EV 12 and/or control various aspects or functions of the primary EV 12, some of which are listed above. Additionally, one or more apps may allow the user to connect with the remote facility 80 or call center advisors at any time.

Additionally, and in at least one embodiment, the primary EV user and/or the secondary EV user may also have more than one wireless device 90, such as a work smartphone and a personal smartphone, which may be linked by the charge session swap app 92/98. The devices associated with the primary EV 12 (or user thereof) can be referred to generally as primary EV devices, whereas the devices associated with the secondary EV 14 (or user thereof) can be referred to generally as secondary EV devices.

The charge session swap apps 92 and 98 are wireless device applications that may act to establish and carry out the parts of the charge session swap such as the identification of the primary EV, submission of request, exchange of charge priority metrics, response to request, confirmation of charging session swap and, exchange of charge bid. In the discussion that follows, any of the functions or other features described for one of the charging session swap app 92 and 98 may be included in the other app as well if needed or desired. The charging session swap app 92,98 uses the SRWC capability to provide access to the primary EV 12 within a specified distance or range from the vehicle (e.g., a fifty foot radius from the vehicle). In some embodiments, the charge session swap apps 92 and 98 may also have the capability of sending and receiving information from one or more other wireless devices (e.g., the primary EV users wireless device 90 to the service provider's wireless device 94 or 96) that also have the charge session swap app for purposes of transferring vehicle information and/or for other applicable communications. In some other embodiments, the charge session swap app may have the capability of communicating with the vehicle system and transferring data between the wireless application and the wireless communications device 30. The charge session swap apps 92 and 98 are also capable of communicating with the remote facility 80.

The processors of the wireless devices 90 and 96 may also execute an operating system for the handheld device, such as Android™, iOS™, Microsoft Windows™, and/or other operating systems. The operating systems may provide a user interface and a kernel, thereby acting as a central control hub that manages the interfacing between the hardware and software of the device. Moreover, the operating systems may execute mobile apps, software programs, and/or other software or firmware instructions. The processors can execute the charge session swap app 92 that enables a user of a primary EV to store user information at a central facility and allows for to data to be exchanged, confirmation/denial of request, confirmation of execution of charge session swap and initiation of crediting the primary EV's account. The memory of the wireless device 90, 94, or 96 may include RAM, other temporary powered memory, any non-transitory computer-readable medium (e.g., EEPROM), or any other electronic computer medium that stores some or all of the software needed to carry out the various external device functions discussed herein. In other embodiments, the memory of the wireless device 90, 94, or 96 may be a non-volatile memory card, such as a Secure Digital™ (SD) card, that is inserted into a card slot of the wireless device 90 or 96.

The wireless devices 90 and 96 can include a SRWC circuit and/or chipset, as well as one or more antennas, which enablers carrying out SRWC, such as any of the IEEE 802.11 protocols, WiMAX™, ZigBee™, Wi-Fi Direct™, Bluetooth™ (including Bluetooth™ Low Energy (BLE)), or near field communication (NFC). The SRWC circuit and/or chipset may allow the wireless device 90 or 96 to connect to another SRWC device, such as wireless communications device 30 of EV 12 (or a wireless communications device of EV 14). Additionally, the wireless device 90 or 96 may include a cellular chipset thereby allowing the device to communicate via one or more cellular protocols, such as GSM/GPRS technology, CDMA or CDMA2000 technology, and/or LTE technology. The wireless device 90 or 96 may communicate data over the wireless carrier system 70 using a cellular chipset and an antenna.

The electric vehicle charging facility 82 is a stationary facility that includes one or more electric vehicle charging stations 88 that can be used to charge a battery of an electric vehicle, such as EVs 12 and 14. The charging facility 82 can be located at a parking facility, a dedicated EV charging facility, a gas station, a vehicle service facility, a residence, or any other location that includes an EV charging station (or stall) 88. EV charging facility 82 can be connected to an electrical power grid that can be used to receive electricity from one or more power plants. The electricity can be communicated over various power lines, transformers, and/or other infrastructure. Additionally, the electricity can be delivered via alternating current (AC) and then converted into direct current (DC) at the charging station, and/or may otherwise be transformed to comply with the requirements or recommended guidelines of the one or more charging stations 88. In one embodiment, the charging facility 82 can be a parking structure that is a Level 2 or Level 3 charging station, or can be a dedicated charging facility 82 that is a Level 2 or Level 3 charging station. In at least one embodiment, the charging facility 82 can be a home residence and can include a Level 1 charging station (e.g., a wall-outlet type connector).

In addition to the EV charging station 88, the EV charging facility 82 can include other electronics, such as a computer (or stationary wireless device) 84 that can be used to communicate with other devices or components of system 10, including the EVs 12,14 and the mobile wireless devices 90,96. The computer 84 can be a SRWC device and can include a SRWC circuit or chipset, such as the one described above with respect to the mobile wireless devices 90,96. Moreover, as discussed below, the first mobile wireless device 90 may be associated or a part of the EC charging facility 82 and usable by an operator or agent of the EV charging facility 82. Thus, either through use of the computer or the first mobile wireless device 90, the EV charging facility 82 may be able to access one or more such apps that enable it to communicate with the computer 78, remote facility 80, and/or mobile wireless devices 90 and 96 to exchange information, including notifications and access credentials for carrying out the methods described herein.

The electric vehicle charging station 88 is a kiosk for providing electrical charge to a battery of an electric vehicle. At least in some embodiments, the charging station 88 includes an interface for charging an EV and a charging cord that can be used to deliver electricity from the station 88 to the EV 12,14. The EV charging station 88 can include various electronics, including an electric power converted (e.g., an alternating current/direct current (AC/DC) converter), transformers, ground fault circuit interrupters (GFCI), and/or various other hardware components used for electric power or energy conversion. Electric power can be delivered from the station 88 to the vehicle via the charging cord, which can include a male or female connector that complements a connector on the EV 12,14. For example, the charging cord can include a standard connector or other suitable connector. In one embodiment, an SAE J1772 connector, a wall outlet type connector (e.g., Nema 515, Nema 520), a CHAdeMO connector, an SAE Combo CCS connector, a Tesla HPWC or supercharger connector, or other connector, which can depend on the charging level (i.e., Level 1, Level 2, or Level 3).

In some embodiments, communications may be carried out over the charging cord such as through using power line communications (PLC) or a dedicated communications line within the charging cord. In such a case, a modem for modulation and demodulation of communication signals can be included at the charging station and coupled to the charging cord (or communication line) and at the EV 12,14 and coupled to the charging system module included therein (e.g., charging electronics 40 of EV 12).

Additionally, the EV charging station 88 can include a user interface that enables a user to communicate (i.e., provide input and receive output) with the charging station 88. This can include a graphical display, an audio speaker, one or more push buttons, currency insertion slots or collection ports, magnetic strip readers (e.g., for reading a credit or debit card), radio frequency identification (RFID) readers or tags (e.g., active or passive RFID devices or components), short-range wireless communication (SRWC) circuit or chipset, cellular chipset, and/or various other electrical components.

In some embodiments, the service provider may use multiple portable wireless devices 90 or stationary wireless devices 84. Moreover, the primary EV user and the secondary EV user may have more than one wireless device 90. One embodiment may use the mobile wireless device 90 for communications while another embodiment may instead use the stationary wireless device 84 located at or near the service facility. In another embodiment, the portable wireless device 90 may be used for part of the charging session swap process while the stationary wireless device 84 may be used for the other part of the charging session swap process.

The primary electric vehicle (EV) 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. While the primary EV 12 and its electronics 20 are discussed below in detail, the secondary EV 14 can include the same or similar electronics 20 and, thus, the discussion below of electronics 20 is hereby attributed to vehicle electronics (not shown) of the secondary EV 14.

Some of the vehicle electronics 20 are shown generally in FIG. 1 and may include a global navigational satellite system (GNSS) receiver 22, a body control module (BCM) 24, the wireless communications device 30, charging electronics 40, a vehicle system module (VSM) 48, and numerous other components and devices. Some or all of the different vehicle electronics 20 may be connected for communication with each other via one or more communications busses. A communications bus 44 provides the vehicle electronics with network connections using one or more network protocols. Examples of suitable network connections include a controller area network (CAN), a media oriented system transfer (MOST), a local interconnection network (LIN), a local area network (LAN), and other appropriate connections such as Ethernet or others that conform with known ISO, SAE and/or IEEE standards and specifications, to name but a few.

The primary EV 12 as well as the secondary EV 14 can include a variety of communication and control system components in the vehicle electronics 20, such as the global navigation satellite system (GNSS) receiver 22, the BCM 24, the wireless communications device 30, the charging electronics 40, push buttons 52, audio system 54, and display 58, as will be described below. The EVs can also include other VSMs 48 in the form of electronic hardware components that are located throughout the vehicle and which may receive input from one or more sensors and use the sensed input to perform diagnostic, monitoring, control, reporting, and/or other functions. For example, the other VSMs 48 may include a center stack module (CSM), an infotainment unit, a powertrain control module, and/or a transmission control unit. Each of the VSMs 48 can be connected by the communications bus 44 to the other VSMs 48 as well as to the wireless communications device 30 and can be programmed to run vehicle system and subsystem diagnostic tests to check for things such as charge level. One or more of the VSMs 48 may periodically or occasionally have its software or firmware updated and, in some embodiments, such vehicle updates may be over the air (OTA) updates that are received from the computer 78 or the remote facility 80 via the land network 76 and/or the wireless communications device 30. As is appreciated by those skilled in the art, the above-mentioned VSMs 48 are only examples of some of the modules that may be used in the vehicle 12, as numerous others are also possible.

The global navigation satellite system (GNSS) receiver 22 receives radio signals from a constellation of the GNSS satellites 60. From these signals, the receiver 22 can determine the position of the primary EV 12 which may enable the primary vehicle 12 to determine whether it is at a known location, such as home or workplace or at a charging facility or station 82. Moreover, the GNSS receiver 22 can provide this location data to the wireless communications device 30, which can then use this data to identify known locations, such as an EV user's home, workplace or charging facility or station. Additionally, the GNSS receiver 22 may be used to provide navigation and other position-related services to the vehicle operator such as the location of the next nearest charge facility. Navigation information can be presented on a display 58 (or other display within the vehicle) or can be presented verbally such as is done when supplying turn-by-turn navigation. The navigation services can be provided using a dedicated in-vehicle navigation module (which can be part of the GNSS receiver 22), or some or all navigation services can be done via the wireless communications device 30 installed in the primary EV 12, wherein the position information is sent to a remote location for purposes of providing the primary EV 12 with navigation maps, map annotations (points of interest, charging facility, etc.), route calculations, and the like. The position information can be supplied to the remote facility 80 or other remote computer system, such as the computer 78, for other purposes, such as fleet management. Also, new or updated map data can be downloaded to the GNSS receiver 22 from the remote facility 80 via a vehicle wireless communications device 30.

The body control module (BCM) 24 is shown in the exemplary embodiment of FIG. 1 as being electrically coupled to communication bus 28. In some embodiments, the BCM 24 may be integrated with or part of a center stack module (CSM) and/or integrated with wireless communications device 30. Or, the BCM may be a separate device that is connected to other VSMs via bus 44. BCM 24 can include a processor and/or memory, which can be similar to processor 36 and memory 38 of wireless communications device 30, as discussed below. BCM 24 may communicate with wireless device 30 and/or one or more vehicle system modules, such as an engine control unit (ECU) (not shown), GNSS receiver 22, AVC 46, audio system 54, or other VSMs 26. BCM 24 may include a processor and memory accessible by the processor. Suitable memory may include non-transitory computer-readable memory that includes various forms of non-volatile RAM and ROM. Software stored in the memory and executable by the processor enables the BCM to direct one or more vehicle operations including, for example, controlling central locking, air conditioning, power mirrors, controlling the vehicle primary mover (e.g., engine, primary propulsion system), and/or controlling various other vehicle modules. For example, the BCM 24 can send signals to other VSMs, such as a request for sensor information. And, the BCM 24 may receive data from VSMs, including sensor readings or sensor data from various VSMs 48.

Additionally, BCM 24 may provide vehicle state information corresponding to the vehicle state or of certain vehicle components or systems. For example, the BCM may provide the device 30 with information indicating whether the vehicle's ignition is turned on, the gear the vehicle is presently in (i.e. gear state), and/or other information regarding the vehicle. The BCM 24 can obtain information from one or more other vehicle modules to obtain this information. Moreover, as mentioned above, the BCM 24 can be used to carry out a variety of vehicle functions.

A vehicle function is any function or operation that may be performed by the primary EV 12, including initiating or booting the wireless communications device 30, a GNSS module, an infotainment unit, a center stack module (CSM), or the other VSM 48. Additionally, a vehicle function may be starting the ignition or primary propulsion system, heating or cooling passenger seats included in the vehicle 12, performing air conditioning or heating of the vehicle 12 cabin, turning off/on or flashing headlights or other lights included in the vehicle 12, emitting an audible sound using the vehicle 12 horn or speakers (such as those included in the audio system 54), downloading information (e.g., information pertaining to the EVs 12 and 14 charge time window) or content data (e.g., audio/video playlists or files) from the remote facility 80 or the computer 78 (including information that may be particular to the user of an SRWC device and/or associated with an SRWC device), downloading or uploading information and/or content data from or to the SRWC device, and/or performing various other operations of the vehicle 12, many of which are described herein.

The wireless communications device (or wireless communications transceiver) 30 includes a short-range wireless communications (SRWC) circuit or chipset 32, a cellular chipset 34, a processor 36, memory 38, and/or antennas 33 and 35 (e.g., a single antenna, dual antenna, or any appropriate number of antennas). In some embodiments, the cellular chipset 34 may be included in a separate vehicle module, such as a telematics unit. And, in some embodiments, the wireless communications device 30 can include the cellular chipset 34 and can be referred to as a telematics unit. The wireless communications device 30 can be an OEM-installed (embedded) or aftermarket device that is installed in the primary EV 12 and that enables wireless voice and/or data communication over the wireless carrier system 70 and via wireless networking. This enables the primary EV 12 to communicate with the remote facility 80, other telematics-enabled vehicles, or some other entity or device. The wireless communications device 30 can use radio transmissions to establish a communications channel (a voice channel and/or a data channel) with the wireless carrier system 70 so that voice and/or data transmissions can be sent and received over the channel. By providing both voice and data communication, the wireless communications device 30 enables the EVs to offer a number of different services including those related to charge session swap, navigation, car sharing, telephony, emergency assistance, diagnostics, infotainment, etc. Data can be sent either via a data connection, such as via packet data transmission over a data channel or via a voice channel using techniques known in the art. For combined services that involve both voice communication and data communication, the system can utilize a single call over a voice channel and switch as needed between voice and data transmission over the voice channel, and this can be done using techniques known to those skilled in the art.

According to one embodiment, the wireless communications device 30 utilizes cellular communication according to either GSM, CDMA, or LTE standards and, thus, includes the standard cellular chipset 34 for voice communications like hands-free calling, a wireless modem for data transmission and a dual antenna 35. It should be appreciated that the modem can either be implemented through software that is stored in the wireless communications device and is executed by the processor 36, or it can be a separate hardware component located internal or external to the wireless communications device 30. The modem can operate using any number of different standards or protocols such as LTE, EVDO, CDMA, GPRS, and EDGE. Wireless networking between the primary EV 12 and other networked devices can also be carried out using the wireless communications device 30. For this purpose, the wireless communications device 30 may use the SRWC circuit 32 to communicate wirelessly according to one or more wireless protocols, including SRWC such as any of the IEEE 802.11 protocols, WiMAX, ZigBee™, Wi-Fi™ direct, Bluetooth™, Bluetooth™ Low Energy (BLE), or near field communication (NFC). When used for packet-switched data communication such as TCP/IP, the wireless communications device can be configured with a static IP address or can set up to automatically receive an assigned IP address from another device on the network such as a router or from a network address server.

The processor 36 can be any type of device capable of processing electronic instructions including microprocessors, microcontrollers, host processors, controllers, vehicle communication processors, and application specific integrated circuits (ASICs). It can be a dedicated processor used only for the wireless communications device 30 or can be shared with other vehicle systems. The processor 36 executes various types of digitally-stored instructions, such as software or firmware programs stored in the memory 38, which enable the wireless communications device to provide a wide variety of services. For instance, the processor 36 can execute programs or process data to carry out at least a part of the method discussed herein.

In some embodiments, the wireless communications device 30 can be used to provide a diverse range of vehicle services that involve wireless communication to and/or from the primary EV 12. Such services may include: semi-autonomous or fully-autonomous vehicle operation and control; turn-by-turn directions and other navigation-related services that are provided in conjunction with the GNSS receiver 22; airbag deployment notification and other emergency or roadside assistance-related services that are provided in connection with one or more collision sensor interface modules such as BCM 24; diagnostic reporting using one or more diagnostic modules; and/or infotainment-related services where music, webpages, movies, television programs, videogames and/or other information is downloaded by an infotainment module (not shown) and is stored for current or later playback. The above-listed services are by no means an exhaustive list of all of the capabilities of the wireless communications device 30, but are simply an enumeration of some of the services that the wireless communications device may be capable of offering. Furthermore, it should be understood that at least some of the aforementioned modules could be implemented in the form of software instructions saved internal or external to the wireless communications device 30. The aforementioned modules could be hardware components located internal or external to the wireless communications device 30, or they could be integrated and/or shared with each other or with other systems located throughout the EV 12, to cite but a few possibilities. In the event that the modules are implemented as the VSMs 48 located external to the wireless communications device 30, they could utilize the vehicle bus 44 to exchange data and commands with the wireless communications device 30.

Autonomous vehicle controller (AVC) 46 may control certain operations of the vehicle, such as by providing torque and/or braking commands. AVC 46 may be used with fully autonomous vehicle systems or may be used with any suitable autonomous or semi-autonomous vehicle systems (e.g., Levels 0-4 of the National Highway Traffic Safety Administration's (NHTSA) scale of vehicle automation). AVC 46 may use information received from GNSS receiver 22, such as geolocation data (e.g., latitudinal and longitudinal coordinates), and/or information received from a remote facility via wireless device 30, such as GNSS corrections data received from a GPS/GNSS corrections facility 18.

The charging electronics or circuit 40 can be a VSM that include circuitry enabling electricity to be received and then stored in vehicle battery 42. The charging electronics can include various transformers, AC/DC (or DC/AC) converters, and/or other various circuitry that enables electricity received from the station 88 to be stored in battery 42. Moreover, the charging electronics can include or at least be coupled to a charging connector, port, or interface that is complementary to the charging connector of the station 88.

Battery 42 is used to provide power to a vehicle primary mover (or propulsion motor(s)) that are used to propel the vehicle. In many embodiments, the battery may be used in a hybrid or electric vehicle for purposes of powering vehicle electronics, propelling the vehicle, or both (e.g., a 100-600 V lithium-ion or nickel-metal hydride battery). As shown, battery 42 is connected to a charging electronics 40, which may include one or more hardware components that provide the battery with the appropriate or desired amount of current, charge, and/or voltage. Additionally, the charging electronics 40 may include devices or components that provide data concerning the battery 42, such as an Amp-hour meter that measures the Amp-hours that the battery can provide. In one embodiment, charging electronics 40 can be coupled to one or more alternators that charge the battery when the vehicle is moving or the axle of the vehicle is rotating. In another embodiment, charging electronics 40 may be coupled and/or may include a regenerative braking apparatus such that the energy generated thereby is provided to battery 42. And, additionally or alternatively, the battery 42 can provide one or more vehicle modules with electrical power. The battery can provide energy to these modules when the vehicle is running or can provide auxiliary power to vehicle modules when the vehicle is off.

The vehicle's electronics 20 also include a number of vehicle user interfaces that provide vehicle occupants with a means of providing and/or receiving information, including a pushbutton(s) 52, an audio system 54, a microphone 56, and the visual display 58. As used herein, the term “vehicle user interface” broadly includes any suitable form of vehicle telematics such as an electronic device, including both hardware and software components, which is located on the vehicle and enables a vehicle user to communicate with or through a component of the vehicle. The pushbutton(s) 52 allow manual user input into the wireless communications device 30 to provide other data, response, or control input. The audio system 54 provides audio output to a vehicle occupant and can be a dedicated, stand-alone system or part of the primary vehicle audio system 54. According to the particular embodiment shown here, the audio system 54 is operatively coupled to both the vehicle bus 44 and an entertainment bus (not shown) and may provide AM, FM, and satellite radio, CD, DVD and other multimedia functionality. This functionality can be provided in conjunction with or independent of an infotainment module. The microphone 56 provides audio input to the wireless communications device 30 to enable the driver or other occupant to provide voice commands and/or carry out hands-free calling via the wireless carrier system 70. For this purpose, it can be connected to an on-board automated voice processing unit utilizing human-machine interface (HMI) technology known in the art. The visual display or touch screen display 58 is preferably a graphics display on the instrument panel or a heads-up display reflected off of the windshield and can be used to provide a multitude of input and output functions. Various other vehicle user interfaces can also be utilized, as the interfaces shown in FIG. 1 are only an example of one particular implementation.

With reference to FIG. 2, there is an embodiment of a method 200 for establishing and carrying a request for a real-time charge session swap. While the method 200 is described in conjunction with the real-time charge session swap system 10 of FIG. 1, it is possible for one or more embodiments of the method 200 to be used with other implementations of a real-time charge session swap system.

The steps of the method 200 discussed below may be carried out via a service provider, an application, or some combination of both. When utilizing a service provider some information may be conveyed directly to or routed through the service provider in order for it to reach the intended recipient, primarily being either the primary EV user, the secondary EV user or, in some instances a computing device. If an application is being utilized it may require that a user account is established and stored at a central facility, such as remote facility 80. When the application (such as charge session application 92,98) is utilized on the mobile wireless device, the application can access the user account at the central facility and proceed with conveying any or all of the following; a request for charge session swap, charge priority metrics, acceptance of the request and notification of the response. Once the secondary EV 14 is notified of acceptance, and execution of the swap is confirmed the application may also be able to allocate a credit specified in the charge bid to the account of the primary EV user.

The method 200 begins with the step 210, wherein a primary EV 12 is identified. To initiate the communication necessary for the charge session swap, the primary EV 12 should be identified to allow for a system of communication to be established. Identification of the primary EV 12 by the secondary EV 14 can be accomplished via a variety of methods. In one scenario, the secondary user (the user of the secondary EV 14) can utilize the second mobile wireless device 96 (for example a handheld wireless device) to provide the identification information to the computing system. This may be accomplished by the secondary EV 14 user scanning a visible identifier (not shown) using a mobile wireless device or manually inputting information from a visible identifier into a mobile wireless device. The visible identifier could be something associated with the vehicle such as a license plate, VIN number or, a windshield sticker. Additionally, the identifier could not be associated with the vehicle and instead it could be associated with the charging station 88 itself. An example of an identifier for the charging station could be a QR code. Again as with the identifier associated with the vehicle the identifier may be entered manually in to the mobile wireless device or by scanning. In another scenario the secondary EV 14 can automatically obtain the identification information of the primary EV 12 using short range wireless communication 39 between the primary and secondary EVs 12 and 14 or between secondary EV 14 and the charging station 88 or the charging facility 94. In yet another scenario the secondary EV 14 can obtain the identity of the primary EV 12 directly via wireless transponders in installed in each of the EVs.

For example, a user of the secondary EV 14 (or the secondary EV 14 itself) may make a determination that the primary EV 12 is occupying the charging station 88 that the secondary EV 14 would like to use. The secondary EV 14 identifies the primary EV 12 via a visual identifier or an electronic identifier. This may be accomplished via the secondary EV user manually inputting identification information into the second mobile wireless device 96, via vehicle-to-vehicle (V2V) communications between the primary EV 12 and the secondary EV 14 (e.g., using the wireless communications device 30), or via other communication channels between the EVs 12,14 and/or the mobile wireless devices 90,96 using SRWC. It is also possible that instead of identifying the primary EV, the secondary EV may identify the charging station 88 in a similar manner to that described above for identifying the primary EV. Communication between the secondary EV 14 and the charging station 88 can be carried out locally, such as through using charging facility computer 84 at the charging facility 82 or a computer included in charging station 88, or remotely, such as through using a remote device including computer 78 or servers at a remote facility 80.

Generally speaking, each step of the method described herein for initiating, executing, and confirming a charge session swap can be completed by any of the SRWC devices (e.g., wireless communication device 30 of EV 12, wireless communication device (not shown) of EV 14, first mobile wireless device 90, second mobile wireless device 96, computer 84) or other communication devices. Additionally, according to various embodiments, the method can use multiple communication paths, the method can be carried out using numerous devices, and/or a user may utilize different devices throughout the method. For example, the secondary EV 14 user may initiate the request using the second mobile wireless device 96 to identify the primary EV 12 and then use the wireless communications device 30 to convey charge priority metrics, as discussed more below. Furthermore, the initial request (step 220) could be sent to the wireless device 30 of primary EV 12 and the primary EV 12 user may respond using the first mobile wireless device 90. This is by no means an exhaustive list of how alternative paths and devices may be used and, thus, a variety of other combination could be employed as well. The method 200 continues to step 220.

In step 220, a request for a charge session swap (or a “charge session swap request”) is sent to the primary EV 12, which receives the request. The request may be generated and sent directly from a wireless device associated with the secondary EV 14 (a “secondary EV device”), including a wireless communications device included in the secondary EV 14 or the second mobile wireless device 96. The request can be sent directly to a device associated with the primary EV (a “primary EV device”) (e.g., wireless communications device 30 included in the primary EV 12 or the first mobile wireless device 90) via SRWC. Or, in other embodiments, the request may be sent from a secondary EV device via the remote facility 80, a stationary wireless device located at the charge facility 82 (e.g., computer 84), a stationary wireless device located at charge station 88, or other central facility.

The charge session swap request can be initiated based on manual input from a user of the secondary EV 14 (or device 96), or may be generated automatically without manual input from a user. For example, manual input can include communicating using one or more interfaces on or connected to the second mobile wireless device 96, communicating through an instrument panel interactive touch screen display (e.g., a display analogous to display 58 can be included in EV 14), communicating verbally through the vehicle's microphone/audio system (e.g., a microphone and/or audio system analogous to microphone 56 and audio system 54, respectively, can be included in EV 14), through sending other wireless message to the primary EV user, or by any other means of inputting information into the secondary EV device. The method 200 continues to step 230.

In step 230, charge priority metrics of the secondary EV owner are received. Charge priority metrics may include charge need metrics and charge bid metrics. Charge need metrics may include relevant data such as the departure time of the secondary EV, present state of energy, and/or the distance to the next destination of the secondary EV. Charge bid metrics may include a variety of types of incentives that the secondary EV 14 is willing to provide to the primary EV 12 upon acceptance or execution of the charge session swap request. Some of these charge priority metrics may originate from the secondary EV 14, such as battery state of charge, some might originate by the secondary EV user (e.g., distance to destination) and some might originate at the data facility 80 (e.g., as might be associated with a subscriber account for the secondary EV user). These charge priority metrics may be included as a part of the charge session swap request or provided after the request is initially made. Once the primary EV 12 has received the charge priority metrics, the primary EV 12 can either accept or deny the request (step 240). If the primary EV 12 accepts the request the system will notify the secondary EV 14 that the charging station is available for use. Furthermore, when a charge bid is provided and accepted, the communications system 10 can confirm execution of the electric vehicle charge session swap and initiate a payment from the user of the secondary electric vehicle to the user of the primary electric vehicle based on the charge bid.

The charge priority metrics may be received by the user of the primary EV 12 at charge session swap application 92, or at another user mobile wireless device such as primary EV 12. In a particular embodiment, a SRWC channel can be established between the first mobile device 90 and the second mobile device 96. Moreover, the charge session swap applications 92 and 98 can be used to send and receive communications over the SRWC channel. In another embodiment, the applications 92 and 98 may share data or information via a remote connection (e.g., via wireless carrier system 70 and/or remote facility 80) or via a connection with a local wireless access point (WAP) or hotspot. The local WAP or hotspot can be located at the EV charging facility 82 and can be incorporated into computer 84 or station 88. The method continues on to step 240.

It should be noted that the request and charge priority metrics could be sent separately or together. There are several routes in which this data can be communicated from the secondary EV device to the primary EV device. For example, the request and/or charge priority metrics can be received directly by the mobile wireless device of the primary EV via an application stored on the mobile wireless devices (e.g., application 92 or similar application stored at vehicle electronics 20 of EV 12) or, it can be delivered via a service provider using at least one computing device having an electronic processor, computer readable memory accessible by the processor, and software stored on the memory that, when executed by the processor, carries out the communications discussed above.

Steps 220-230 include communicating charge priority metrics to a primary EV (or user thereof) from a secondary EV (or user thereof). The communication between a primary EV device and a secondary EV device may include bilateral communications, which may include responding to a series of prompts or back-and-forth communications via the remote facility 80, SRWC circuits, and/or using the app software 92,98 located on the mobile wireless devices 90,96. For example, the primary EV 12 mobile wireless device may prompt the primary EV user to input notification preferences, payment preferences, and contact preferences which may then be relayed to a service provider. Alternatively, the notification may be provided to the operator from the vehicle or remote facility via other means such as charge session swap app 92,98.

In step 240, the primary EV determines whether to accept or deny the request. The primary EV may make the determination automatically based on the charge priority metrics and/or a weighted scoring function that is weighted based on data received from the primary EV user. The weights for scoring the secondary EV users charge priority metrics can be utilized to evaluate overall secondary EV priority based on charge need and charge bid. The primary EV can specify how they value the charge bid versus a need of the secondary EV to charge. Ultimately, the secondary EV needs to score above a minimum overall score to engage in a charge session swap. The charge priority metrics may include a primary EV minimum state of charge (or energy), a minimum charge need for the secondary EV, and a minimum charge bid. In one embodiment, the primary EV may determine to accept the request when a primary EV minimum state of charge (SoC) is met, when the secondary EV charge need meets a particular threshold, and when the secondary EV meets a minimum or threshold charge bid. All of these factors and any other additional factors can be evaluated based on a weighted scoring function. Once a score is established, the score can either be directly provided to the primary EV user so they may use the score to determine whether to grant the request or, in an automated system, the score can be compared against an established or predetermined minimum score to determine if the request should be granted. And, in some embodiments, the established or predetermined minimum score can be generated or based on a state of EV 12 (including state of charge (SoC) of the battery 42), or other information, such as the time of day, a schedule of the user (as stored at the first device 90 or EV 12), or various other information. This scoring function can be implemented on the charge session swap app 92 or the processor 34 of EV 12. In addition, this scoring function could be carried out via the vehicle user interface 58.

When it is automatically determined that the primary EV should relinquish the charging station to the secondary EV, then acceptance of the request for charge session swap and notification to the secondary EV of the acceptance may be carried out automatically as well. It is worth noting that this system can be applied when there are multiple secondary EVs. In the instance when more than one EV is requesting a charge session swap all requesting EVs will be scored and the EV with the score reflecting the greatest need that meets or surpasses the threshold score will win acceptance.

Based on certain user input, the primary EV user, the charge session swap app, or other mobile wireless communication device may desire more information to allow the primary user to adequately respond to the secondary EV user's request. This may include communicating wirelessly through one of the provided communication channels already described above, such as between application 92 and application 98 using devices 90 and 96. At the end of the communication, the primary EV user may have determined whether to accept or deny the request based on the charge priority metrics. The method 200 continues to step 250.

In another embodiment, this grant or denial may be manually inputted by the primary EV user into the vehicle telematics via the vehicle user interfaces 52, 56, 58 or by input into the charge session swap app 92 in response to a prompt requesting acceptance. Furthermore, this step could also be carried out automatically by, for example, application 92 of the first mobile wireless device 90. It could be possible to send the results from the established parameters and weighted scoring process that were applied to the charge priority metrics supplied by the secondary EV directly to the secondary EV device. It could also be possible to enable a process for the primary EV user to override this function if some reason the primary EV user wishes to ignore the result of the automated system and make their own decision to a specific request. Furthermore, it should be appreciated that the primary EV user could decide to send the secondary EV user a simple acceptance or rejection or they could provide a score or some other means of conveying the final decision. The method 200 continues to step 260.

In step 250, the decision reached in step 240 is conveyed to the secondary EV user. The manner of communication here can be the same as that employed in steps 220 and 230. Furthermore, as stated earlier, the information can be sent in any manner available and does not have to be carried out using the same device or communication path as that which was used to communicate the request. Nor does it have to be carried out with the same device or in the same manner as that which was used to carry out the charge priority metrics. The decision may be communicated using the charge session swap app 92 directly via SRWC or via a remote path, such as via the remote facility 80, land network 76, and/or wireless carrier system 70. Once an acceptance of the request is received, execution of the charge session swap can occur. Alternatively, if the request is denied the method 200 ends or, alternatively, the method 200 continues back to step 220 where another request can be generated and send to the primary EV user. In such an embodiment, the second request can include different charge priority metrics, such as different charge bid metrics. The method 200 continues to step 260.

In step 260, execution and confirmation of the charge session swap is established via one of the aforementioned systems and methods used to initiate or carry out the swap. Confirmation provides the clearance to allow for the exchange of the charge bid. The charge session swap may be executed by the primary EV user moving their vehicle and relinquishing control of the charge station 88 so that the secondary EV 14 may access it.

In yet another embodiment, the primary EV 12 may drive itself autonomously for part or all of the distance to make the charging station available for the secondary EV 14. In such a case, the vehicle may preferably be outfitted with an autonomous vehicle controller 46 (AVC) located in the communication bus 44. It may also require an engine control unit (ECU) (in the case of a hybrid electric vehicle) that is also couple to the communication bus 44. EV 12 could move merely enough to free up the station or EV 12 could move itself to an available parking spot at the charging facility 82 and then may park thereat. In one scenario where the service provider controls or owns the mobile wireless device used to operate the primary EV 12, then the service provider may use that mobile wireless device to receive the access credentials needed to operate and move the vehicle. Or, if such manual operation of the primary EV 12 to move it for the charge session sway is only done at the charging facility, the credentials may be obtained and used by the stationary wireless device (or computer) 84, with the SRWC being used at the service facility to communicate with the primary EV 12 to obtain the needed access to operate the vehicle locally within the range of the SRWC. If the primary EV 12 is moved by autonomous means, the primary EV user may be notified upon completion of the move with information regarding the move, such as the new location of the primary EV 12. This could be accomplished via a service provider or via the charge session swap app 92 using the first mobile wireless device 90. The method 200 continues to step 270.

In step 270, the charge bid amount represented by the charge bid metric is supplied to the user of the primary EV 12 that granted the charge session swap. Payment, credit, or other consideration is transferred from an account associated with the secondary EV (or user thereof) to an account associated with the primary EV (or user thereof) via one of the aforementioned primary EV devices and secondary EV devices, including mobile devices 90,96 and/or wireless communications device 30 (and analogous wireless communications device of EV 14). Additionally, user accounts can be hosted or maintained by a third party account manager, such as PayPal™, Venmo™, QuickPay™, or other account to account payment transfers, such as those established by financial institutions, may be used to execute transfer of the charge bid. The method 200 then ends.

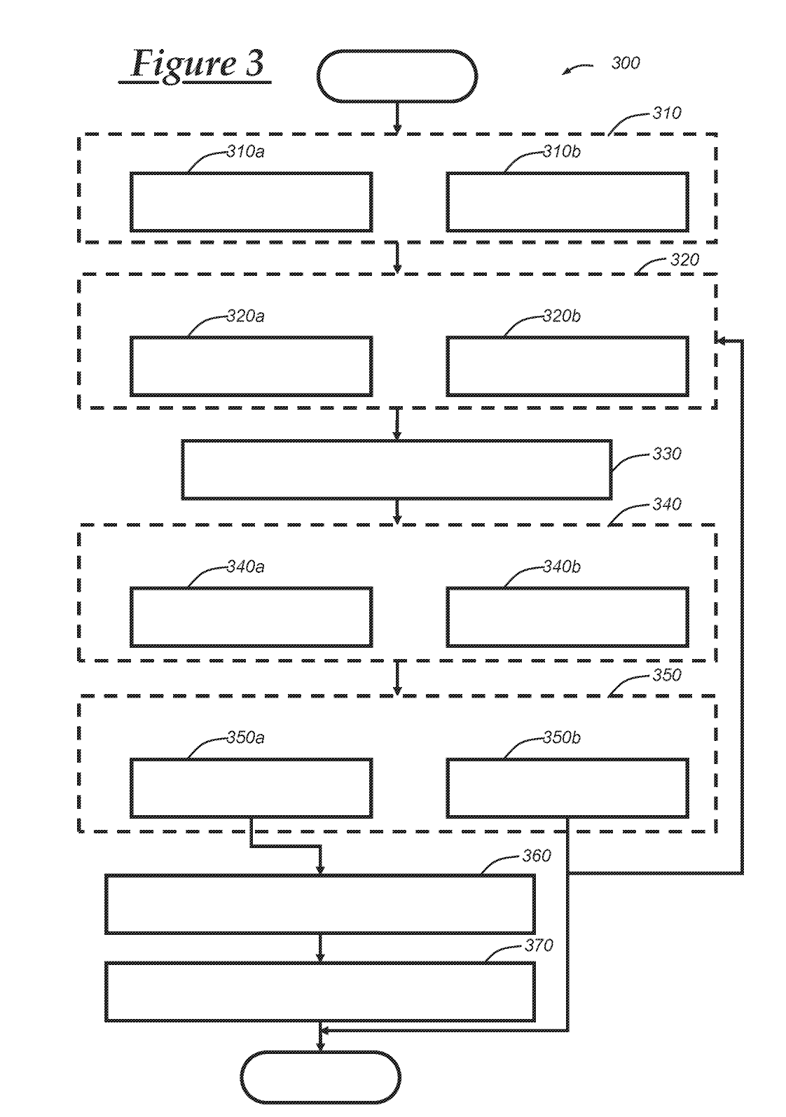

With reference to FIG. 3, there is shown a method of establishing real time charge session swap between a secondary and primary electric vehicle. Many of the steps and methods are similar to those of system 200 described in FIG. 2 and, for purposes of brevity, reference will be made to analogous steps of method 200 in lieu of providing a full discussion.

In step 310, a primary EV 12 is identified. This step is analogous to step 210 of method 200 (FIG. 2) and, thus, the discussion of step 210 is incorporated into step 310. As indicated above, the primary EV 12 can be identified in a variety of ways, including through use of a visual identifier or other passive identifying technique (step 310a) or through communications with EV 12 or another entity, such as remote facility 80 or charging facility 82.

In step 310a, a visual identifier on or at the vehicle, on or at the charge facility 82, or on or at the charge station 88 can be recognized and processed to determine the identity of the primary EV 12. In one embodiment, this can include using a camera included on EV 14 or on the second mobile device 96 that can capture an image of a visual identifier (such as a tag or other identifying symbol or character(s)) and, then, the image can be processed to resolve the EV 12 or the charge station 88 (or facility 82) to a particular vehicle or station. Other passive identifying techniques can include any of those that do not require or desire a response or information from the primary EV or user thereof.

In step 310b, the secondary EV 14 (or a secondary EV device (including device 96)) can be used to generate and communicate an identification request from the primary EV 12 (or primary EV device). This identification request can be a simple ping message that includes a request for a unique identifier of the vehicle, or other identifying information. The method 300 continues to step 320.

In step 320, a request for a real time charge session swap is initiated. Communication with the primary EV 12 may take several different forms, such as via the vehicle or a mobile wireless device. In particular, non-limiting examples include communicating wirelessly through the primary EV users mobile wireless device 90, communicating through the instrument panel interactive touch screen display 58 that enable visual communication, communicating verbally through the vehicle's audio system 54, through sending an email or other wireless message to the primary EV user, or by any other means of communicating between the primary EV 12 and the secondary EV 14. The primary EV's communication to a secondary EV may be a bilateral communication which may include responding to a series of prompts either from the remote facility 80, software on the processor 34, the secondary EV, or the app software 98/92 located on the mobile wireless devices 96/90. For example, the primary EV 12 mobile wireless device may prompt the primary EV user to input notification preferences, payment preferences, and contact preferences which may then be relayed to a service provider. Alternatively, the notification may be provided to the operator from the vehicle or remote facility via other means such as charge session swap app 98/92.

In steps 320a and 320b, the request described above is carried out or communicate to the primary EV or other primary EV device. It is important to note that these steps 320a and 320b represent only two possibilities of many that were described earlier or that are made apparent to those skilled in the art based on the discussion herein. In 320a, the request may be carried out using an application 98 stored on the mobile wireless device 96 of the secondary EV user and can be carried out using a central facility to access a user account. In 320b, the request is carried out using a service provider, which can include using computer 84 or station 88. The method 300 continues to step 330.

In step 330, the request sent by the secondary EV user is received at the primary EV. The request can be received at the first mobile wireless device 90, wireless communications device 30, or other VSM of primary EV 12. This step can be carried out in a similar manner as that of step 220 of method 200 (FIG. 2). This may be done directly from the mobile wireless device 96 that is associated with the secondary EV 14, from the remote facility 80, the stationary wireless device or computer 84 located at the charge facility 82, the charge station 88, or other central facility. The method 300 continues to step 340.

In step 340, a response to the charge session swap request is generated and then communicated. This step is similar to steps 240 to 250 of method 200 (FIG. 2) and, as such, the discussion therein is incorporated into step 340. Steps 340a and 340b are alternative ways of responding to the charge session swap request.

In step 340a, the response may be generated automatically based on pre-configured parameters and a weighted scoring system of the primary EV. This grant may be inputted by the primary EV user in to the vehicle telematics via the vehicle user interfaces 52, 56, 58 or by input into the charge session swap app 92 in response to a prompt requesting acceptance or via any other mode employable by a mobile wireless device.

In step 340b, the primary EV user can enter a decision based on the scoring of an automated system or make it independently of any information provided. If the system is set up to provide an automated response, the results from the established parameters and weighted scoring process can be sent directly to the secondary EV user of secondary EV device. It could also be possible for the primary EV user to override this automated function when the user did not agree with the generated response or when the user desires to manually respond themselves. It is worth noting these parameters and scoring scales could be generated by software and be part of the readable memory or they could be entered by the primary EV or they could be a combination of both. Furthermore, it should be appreciated that the primary EV user could decide to send the secondary EV user a simple acceptance or rejection or they could provide a score or some other means of conveying the final decision.

Once a determination of whether to accept or deny the request is made, this acceptance or denial can be communicated to the secondary EV user (or secondary EV device). This is carried out in similar fashion to that of step 250 of method 200. The method continues in step 350.

In step 350, the response is received at the secondary EV device. This step is analogous to step 250 of method 200 and, thus, such discussion is incorporated herein. In 350a, the primary EV user has granted the request to the primary EV. Here again the grant is conveyed using the same types of communication outlined above in steps 220, 230 and 250. In such a case, the method 300 proceeds to step 360.

In step 350b, the response received indicates that the request was denied. Here, the primary EV expresses that they will not relinquish the charging station and this is included in the response. At this point, the method 300 may end, or may proceed back to step 320, where the secondary EV device (or user) may be allowed to respond or resubmit a second request, in which case the exchange of communication may be executed in the same or similar manner as the initial request described above. Additionally, the primary EV user may provide the results scoring system to the secondary EV user or other relevant information such as the estimated time of when they will complete their charge.

In step 360, the secondary EV 14 is notified that the charge station is available. This can include receiving a confirmation that the primary EV 12 has moved away from the station 88 and/or otherwise relinquished control of the station 88. A primary EV device, such as wireless device 90 or communications device 30, can be used to communicate this to primary EV 12. Or, in an alternative embodiment, this message can be received from the charging facility 82 or station 88. The method 300 then continues to step 370.

In step 370, confirmation of the swap is executed thereby allowing for the transfer of the charge bid from the secondary EV user to the primary EV user. Confirmation of the charge session swap is established via one of the aforementioned systems and processes used to submit the request or response of the charge session swap. The confirmation provides the clearance to allow for the exchange of the charge bid. The charge session swap may be executed by the movement of the primary EV 12 and freeing the charge station so that the secondary EV 14 may access it in connection with an executed or scheduled transfer of the charge bid amount from an account associated with the secondary EV (or user thereof) to an account associated with the primary EV (or user thereof). As described above, this could be done by the user of the primary EV 12 or autonomously if the vehicle has autonomous capabilities. The method 300 then ends.

In one embodiment, the method 200, the method 300, or parts thereof can be implemented in a computer program (or “application”) (e.g., the charge session swap application 92,98) embodied in a computer readable medium and including instructions usable by one or more processors of one or more computers of one or more systems. The computer program may include one or more software programs comprised of program instructions in source code, object code, executable code or other formats; one or more firmware programs; or hardware description language (HDL) files; and any program related data. The data may include data structures, look-up tables, or data in any other suitable format. The program instructions may include program modules, routines, programs, objects, components, and/or the like. The computer program can be executed on one computer or on multiple computers in communication with one another.

The program(s) can be embodied on computer readable media (such as memory 38, memory in BCM 24, memory of devices 90, 96, and/or memory of computer 84), which can be non-transitory and can include one or more storage devices, articles of manufacture, or the like. Exemplary computer readable media include computer system memory, e.g. RAM (random access memory), ROM (read only memory); semiconductor memory, e.g. EPROM (erasable, programmable ROM), EEPROM (electrically erasable, programmable ROM), flash memory; magnetic or optical disks or tapes; and/or the like. The computer readable medium may also include computer to computer connections, for example, when data is transferred or provided over a network or another communications connection (either wired, wireless, or a combination thereof). Any combination(s) of the above examples is also included within the scope of the computer-readable media. It is therefore to be understood that the method can be at least partially performed by any electronic articles and/or devices capable of carrying out instructions corresponding to one or more steps of the disclosed method.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering any one or more of the following: “A”; “B”; “C”; “A and B”; “A and C”; “B and C”; and “A, B, and C.”

1. A method for use in performing a real-time charge session swap between a primary electric vehicle located at a charging station of an electric vehicle charging facility and a secondary electric vehicle located at the electric vehicle charging facility, comprising the steps of:
(a) receiving via a mobile wireless device a request for an electric vehicle charge session swap indicating a request by the secondary electric vehicle for the primary electric vehicle to suspend charging of the primary electric vehicle by the charging station prior to completion of charging by the primary electric vehicle;
(b) receiving one or more charge priority metrics from the secondary electric vehicle indicating a level of need for charging of the secondary electric vehicle;
(c) providing an acceptance of the request for the electric vehicle charge session swap based on an evaluation of the charge priority metrics; and
(d) notifying the secondary electric vehicle of the acceptance, thereby communicating the availability of the charging station for use by the secondary electric vehicle to carry out the electric vehicle charge session swap.

2. The method of claim 1, wherein the steps are carried out by a service provider using at least one computing device having an electronic processor, computer-readable memory accessible by the processor, and software stored on the memory that, when executed by the processor, carries out the steps of the method.

3. The method of claim 1, wherein the charge priority metrics include a charge bid from a user of the secondary electric vehicle, and wherein the method further comprises the steps of providing the charge bid to a user of the primary electric vehicle prior to step (c) and, after step (d), confirming execution of the electric vehicle charge session swap and initiating a payment from the user of the secondary electric vehicle to the user of the primary electric vehicle based on the charge bid.

4. The method of claim 1, wherein the method is implemented at least in part using an application stored on the mobile wireless device of a user of the primary electric vehicle, wherein the application is associated with a primary user account stored at a central facility and, when executed on the mobile wireless device, the application accesses the user account at the central facility, and wherein the method further comprises, after step (d), confirming execution of the electric vehicle charge session swap and initiating a crediting of the primary user account in response to confirming execution of the electric vehicle charge session swap.

5. The method of claim 1, wherein the charge priority metrics include a charge need of the secondary electric vehicle and wherein the method comprises carrying out steps (c) and (d) following a determination that the charge need meets a minimum threshold.

6. The method of claim 1, wherein the request in step (a) for the electric vehicle charge session swap by the secondary electric vehicle is received from a user of the secondary electric vehicle via a handheld wireless device operated by the user or via a telematics unit installed in the vehicle, and wherein notifying the secondary electric vehicle in step (d) of the acceptance comprises notifying the user of the secondary electric vehicle via the handheld wireless device or the telematics unit.

7. The method of claim 1, further comprising automatically determining the acceptance based on the charge priority metrics and a weighted scoring function that is weighted based on data received from an owner of the primary electric vehicle.

8. The method of claim 7, wherein the method comprises automatically carrying out the determining step and steps (c) and (d) following a determination that the primary electric vehicle has a minimum state of charge.

9. The method of claim 1, further comprising receiving an identifier of the primary electric vehicle from a user of the secondary electric vehicle via a handheld wireless device carried by the user of the secondary electric vehicle.

10. The method of claim 1, further comprising receiving an identifier of the primary electric vehicle that was obtained automatically by the secondary electric vehicle using short range wireless communication between the primary and secondary electric vehicles.

11. A system for use in performing a real-time charge session swap between a primary electric vehicle located at a charging station of an electric vehicle charging facility and a secondary electric vehicle located at the electric vehicle charging facility, the system comprising a computing device having an electronic processor, computer-readable memory accessible by the processor, and software stored on the memory that, when executed by the processor, configures the system to:
(a) receive via a mobile wireless device a request for an electric vehicle charge session swap indicating a request by the secondary electric vehicle for the primary electric vehicle to suspend charging of the primary electric vehicle by the charging station prior to completion of charging by the primary electric vehicle;
(b) receive one or more charge priority metrics from the secondary electric vehicle indicating a level of need for charging of the secondary electric vehicle;
(c) provide an acceptance of the request for the electric vehicle charge session swap based on an evaluation of the charge priority metrics; and
(d) notify the secondary electric vehicle of the acceptance, thereby communicating the availability of the charging station for use by the secondary electric vehicle to carry out the electric vehicle charge session swap.

12. The system set forth in claim 11, wherein the computing device is located remotely of the electric vehicle charging facility.

13. The system set forth in claim 11, wherein the computing device is located at the electric vehicle charging facility.

14. The system set forth in claim 11, wherein the charge priority metrics include a charge bid from a user of the secondary electric vehicle, and wherein, when executing the software using the processor, the computing device is configured to provide the charge bid to a user of the primary electric vehicle and, after notifying the secondary vehicle of the acceptance, confirm execution of the electric vehicle charge session swap and initiate a payment from the user of the secondary electric vehicle to the user of the primary electric vehicle based on the charge bid.

15. The system set forth in claim 11, wherein the request for the electric vehicle charge session swap by the secondary electric vehicle is received from a user of the secondary electric vehicle via a handheld wireless device operated by the user or via a telematics unit installed in the vehicle, and wherein, when executing the software using the processor, the computing device is configured to notify the user of the secondary electric vehicle of the acceptance via the handheld wireless device or the telematics unit.

16. A non-transitory computer-readable medium for use in performing a real-time charge session swap between a primary electric vehicle located at a charging station of an electric vehicle charging facility and a secondary electric vehicle located at the electric vehicle charging facility, the computer-readable medium having stored thereon software that, when executed by an electronic processor, configures the processor to:
(a) receive via a mobile wireless device a request for an electric vehicle charge session swap indicating a request by the secondary electric vehicle for the primary electric vehicle to suspend charging of the primary electric vehicle by the charging station prior to completion of charging by the primary electric vehicle;
(b) receive one or more charge priority metrics from the secondary electric vehicle indicating a level of need for charging of the secondary electric vehicle;
(c) provide an acceptance of the request for the electric vehicle charge session swap based on an evaluation of the charge priority metrics; and
(d) notify the secondary electric vehicle of the acceptance, thereby communicating the availability of the charging station for use by the secondary electric vehicle to carry out the electric vehicle charge session swap.
